(19) United States
(12) Patent Application Publication
(10) Pub. No.: US 2026/0153987 A1
(43) Pub. Date: Jun. 4, 2026

(54) STORAGE DEVICE, OPERATING METHOD OF STORAGE DEVICE, AND COMPUTING SYSTEM

(71) Applicant: Samsung Electronics Co., Ltd., Suwon-si (KR)

(72) Inventor: Sooyoung Ji, Suwon-si (KR)

(21) Appl. No.: 19/390,010

(22) Filed: Nov. 14, 2025

(30) Foreign Application Priority Data
Nov. 29, 2024 (KR) 10-2024-0175820

(51) Int. Cl. G06F 3/06

(52) U.S. Cl. CPC G06F 3/0608; G06F 3/0646; G06F 3/0656; G06F 3/0679

(57) ABSTRACT

A storage device includes non-volatile memory, a storage controller configured to receive a write command and write data from a host device, a compressor configured to compress the write data and write the compressed data to the non-volatile memory, and buffer memory used by the host device, wherein the storage controller is configured to, based on a previous maximum usage of the non-volatile memory and a compression ratio of the compressed data, set a compression reserved space of the non-volatile memory as an additional space of the buffer memory and transmit information on the additional space to the host device.

### CROSS-REFERENCE TO RELATED APPLICATION

This application is based on and claims priority under 35 U.S.C. § 119 to Korean Patent Application No. 10-2024-0175820, filed on Nov. 29, 2024, in the Korean Intellectual Property Office, the disclosure of which is incorporated by reference herein in its entirety.

### BACKGROUND

Recently, storage devices that include non-volatile memory, such as solid state drives (SSDs), have been widely used. The storage devices are useful for storing or transferring large amounts of data.

### SUMMARY

The disclosure provides a storage device capable of utilizing a space obtained by compressing write data.

When receiving write commands and write data from host devices, the storage devices may store the write data in non-volatile memory therein. The storage device may compress the write data and store the compressed write data in the non-volatile memory.

According to an aspect of the disclosure, there is provided a storage device including non-volatile memory, a storage controller configured to receive a write command and write data from a host device, a compressor configured to compress the write data and write the compressed data to the non-volatile memory, and buffer memory used by the host device, wherein the storage controller is configured to, based on previous maximum usage of the non-volatile memory and a compression ratio of the compressed data, set a compression reserved space of the non-volatile memory as an additional space of the buffer memory and transmit information on the additional space to the host device.

According to another aspect of the disclosure, there is provided an operating method of a storage device including non-volatile memory, a storage controller, a compressor, and buffer memory, the operating method including receiving, by the storage controller, a write command and write data from a host device, compressing, by the compressor, the write data to generate compressed data, writing, by the compressor, the compressed data to the non-volatile memory, setting, by the storage controller, a compression reserved space of the non-volatile memory as an additional space of the buffer memory, based on previous maximum usage of the non-volatile memory, and transmitting, by the storage controller, additional space information to the host device.

According to another aspect of the disclosure, there is provided a computing system including a host device, a first storage device including first non-volatile memory, a first storage controller, a first compressor, and first buffer memory, and a second storage device including second non-volatile memory, a second storage controller, a second compressor, and second buffer memory, wherein the first storage device is configured to receive a write command and write data and compress the write data to generate compressed data, write the compressed data to the first non-volatile memory, set a compression reserved space of the first non-volatile memory as a first additional space of the first buffer memory, based on a previous maximum usage of the first non-volatile memory, and transfer data stored in the first additional space to the second storage device, when a space for writing the compressed data to the first non-volatile memory is insufficient.

### BRIEF DESCRIPTION OF THE DRAWINGS

Implementations will be more clearly understood from the following detailed description taken in conjunction with the accompanying drawings in which:

FIG. 1 is a block diagram showing a computing system including a storage device according to some implementations;

FIG. 2 is a block diagram illustrating a detailed structure of the storage device according to some implementations;

FIG. 3 is a diagram illustrating some implementations in which data is initially written on a non-volatile memory (NVM) of the storage device according to some implementations;

FIG. 4 is a diagram illustrating some implementations in which data in excess of a previous maximum usage is additionally written on the NVM of the storage device according to some implementations;

FIG. 5 is a diagram illustrating some implementations in which data written on the NVM of the storage device according to some implementations is erased;

FIG. 6 is a diagram illustrating some implementations in which data not exceeding the previous maximum usage is written on the NVM of the storage device according to some implementations;

FIG. 7 is a diagram illustrating an operation of a storage device according to some implementations when a space for writing compressed data on an NVM is insufficient;

FIG. 8 is a diagram illustrating some implementations in which an additional space in a storage device according to some implementations is utilized as a memory pool;

FIG. 9 is a flowchart illustrating an operating method of a storage device, according to some implementations;

FIG. 10 is a flowchart illustrating a method in which the storage device according to some implementations sets the additional space on the basis of the previous maximum usage;

FIG. 11 is a flowchart illustrating a method in which the storage device according to some implementations sets the additional space on the basis of the compression ratio;

FIG. 12 is a flowchart illustrating an operating method of the storage device according to some implementations when a space for writing the compressed data on the NVM is insufficient; and

FIG. 13 is a diagram illustrating a system having a storage device according to some implementations.

### DETAILED DESCRIPTION

Hereinafter, implementations are described in detail with reference to the accompanying drawings.

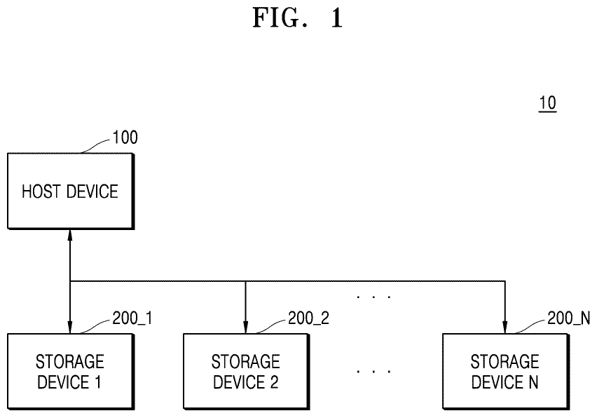

FIG. 1 is a block diagram showing a computing system 10 including a storage device according to some implementations.

Referring to FIG. 1, the computing system 10 according to some implementations may include a host device 100 and a plurality of storage devices 200_1 to 200_N (where N is a natural number greater than or equal to 2). FIG. 1 illustrates some implementations in which the computing system 10 includes N storage devices, but the disclosure is not limited to thereto. The disclosure may also be partially applied to some implementations in which the computing system 10 includes a single storage device.

In some implementations, the computing system 10 may be provided as a PC, a data server, an ultra mobile PC (UMPC), a workstation, a netbook, a network-attached storage (NAS), a smart television, an Internet of Things (IoT) device, an automobile, or a portable electronic product. The portable electronic product may include laptop computers, mobile phones, smartphones, tablet PCs, personal digital assistants (PDAs), enterprise digital assistants (EDAs), digital still cameras, digital video cameras, audio devices, portable multimedia players (PMPs), personal navigation devices (PNDs), MP3 players, handheld game consoles, e-books, wearable devices, and the like.

The host device 100 may control all operations of the computing system 10. In some implementations, the host device 100 may include a processor core, such as a central processing unit (CPU) and an application processor (AP), configured to control the computing system 10, or may include a computing node connected via a network.

The host device 100 may store data in the plurality of storage devices 200_1 to 200_N or may read data stored in the plurality of storage devices 200_1 to 200_N. The host device 100 may generate a write command or a read command for the data.

The host device 100 may transmit the write command and the write data to the plurality of storage devices 200_1 to 200_N to store the data in the plurality of storage devices 200_1 to 200_N. The host device 100 may transmit the read command to the plurality of storage devices 200_1 to 200_N to read data stored in the plurality of storage devices 200_1 to 200_N.

The host device 100 may communicate with the plurality of storage devices 200_1 to 200_N via various interfaces. For example, the host device 100 may communicate with the plurality of storage devices 200_1 to 200_N via an interface that supports a compute express link (CXL) protocol.

Each of the plurality of storage devices 200_1 to 200_N may include storage media for storing data in response to a command from the host device 100. Each of the plurality of storage devices 200_1 to 200_N may be implemented as one of various other types of devices, such as an embedded multimedia card (eMMC), an MMC, a solid state drive (SSD), a universal flash storage (UFS), an embedded universal flash storage (embedded UFS), a reduced size-multimedia card (RS-MMC), a micro-MMC type MMC, a compact flash (CF) card, a secure digital (SD) card, a micro secure digital (Micro-SD) card, a mini secure digital (Mini-SD) card, an extreme digital (xD) card, a smart media card, and a memory stick.

Each of the plurality of storage devices 200_1 to 200_N may perform an operation corresponding to the write command or the read command received from the host device 100. Each of the plurality of storage devices 200_1 to 200_N may store the write data therein in response to the write command. In response to the read command, each of the plurality of storage devices 200_1 to 200_N may internally retrieve the read data corresponding to the read command and transmit the read data to the host device 100.

In some implementations, upon receiving the write command and the write data from the host device 100, each of the plurality of storage devices 200_1 to 200_N may compress the write data and then write the compressed data on non-volatile memory (NVM). In this case, each of the plurality of storage devices 200_1 to 200_N may set a compression reserved space of the NVM as an additional space of a buffer memory on the basis of a previous maximum usage of the NVM and a compression ratio of the compressed data and may transmit information on the additional space to the host device 100.

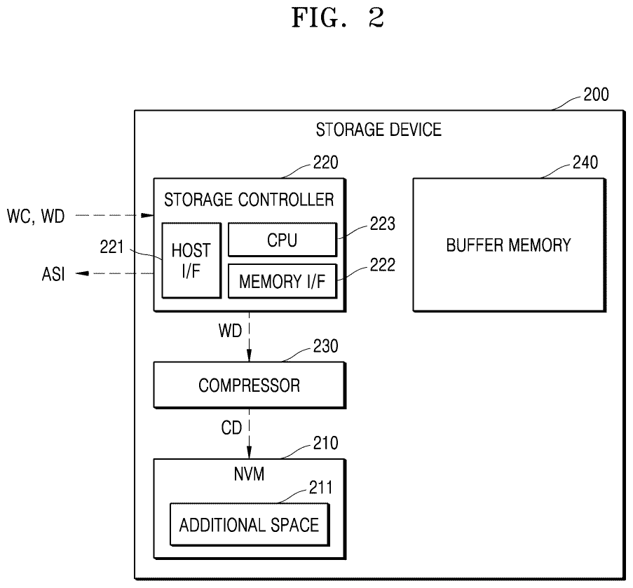

As described above, each of the plurality of storage devices 200_1 to 200_N may set the compression reserved space as the additional space of the buffer memory, and thus, the host device 100 may utilize the space obtained by compressing the write data. Accordingly, free spaces inside the storage devices 200_1 to 200_N may be utilized efficiently. The structure and operation of each of the plurality of storage devices 200_1 to 200_N are described in more detail below with reference to FIG. 2.

FIG. 2 is a block diagram illustrating a detailed structure of a storage device 200 according to some implementations.

Referring to FIG. 2, the storage device 200 according to some implementations may include an NVM 210, a storage controller 220, a compressor 230, and buffer memory 240. The storage device 200 shown in FIG. 2 may represent any one of the plurality of storage devices 200_1 to 200_N shown in FIG. 1.

The NVM 210 may be configured to store data, output the stored data, or erase the stored data, under control of the storage controller 220. In some implementations, the NVM 210 may include a two-or three-dimensional NAND flash memory device, but the disclosure is not limited thereto. The NVM 210 may include memory devices based on various other types of memory, such as magnetic random-access memory (MRAM), spin-transfer torque MRAM (STT-MRAM), conductive bridging RAM (CBRAM), ferroelectric RAM (FeRAM), and phase-change RAM (PRAM), and resistive RAM (RRAM).

The storage controller 220 may control all operations of the storage device 200. The storage controller 220 may include a host interface 221, a memory interface 222, and a CPU 223.

The host interface 221 may be configured to communicate with the host device 100 according to preset interface protocols. In some implementations, the preset interface protocols may include at least one of various other interface protocols, such as an advanced technology attachment (ATA) interface, a serial ATA (SATA) interface, an external SATA (e-SATA) interface, a small computer system interface (SCSI), a serial attached SCSI (SAS) interface, a peripheral component interconnection (PCI) interface, a PCI express (PCIe) interface, an NVM express (NVMe) interface, IEEE 1394, a universal serial bus (USB) interface, an SD card interface, an MMC interface, an eMMC interface, a UFS interface, an embedded UFS (eUFS) interface, a CF card interface, and a network interface. The host interface 221 may receive, from the host device 100, a signal based on the preset interface protocol and operate based on the received signal. For example, the host interface 221 may communicate with the host device 100 by using the CXL protocol.

The memory interface 222 may be configured to communicate with the NVM 210 according to the preset interface protocol. In some implementations, the preset interface protocol may include at least one of various interface protocols, such as a toggle interface and an open NAND flash interface (ONFI). In some implementations, the memory interface 222 may communicate with the NVM 210 on the basis of the toggle interface. In this case, the memory interface 222 may communicate with the NVM 210 via a plurality of channels. In some implementations, the plurality of channels may each include a plurality of signal lines configured to transmit various control signals (e.g., /CE, CLE, ALE, /WE, /RE, R/B, etc.), data signals DQ, and data strobe signals DQS.

The CPU 223 may control all operations of the storage controller 220 as described below.

In some implementations, the storage controller 220 may receive a write command WC and write data WD from the host device 100. The storage controller 220 may store the write data WD in the NVM 210. The storage controller 220 may control the compressor 230 to compress the write data WD into compressed data CD and store the compressed data CD in the NVM 210.

In some implementations, the storage controller 220 may receive a read command from the host device 100. The storage controller 220 may read data from the NVM 210 and transmit the read data to the host device 100. Here, the read data may be decompressed by the compressor 230, and the storage controller 220 may transmit the decompressed read data to the host device 100.

The compressor 230 may compress the write data WD and write the compressed data CD on the NVM 210.

The buffer memory 240 may represent memory that is utilized by the host device 100. The buffer memory 240 is inside the storage device 200 but may be utilized as cache memory by the host device 100.

In some implementations, the storage controller 220 may set a compression reserved space of the NVM 210 as an additional space 211 of the buffer memory 240 on the basis of the previous maximum usage of the NVM 210 and the compression ratio of the compressed data CD.

The previous maximum usage of the NVM 210 may represent the maximum usage of the NVM 210 before the most recent compressed data CD was stored in the NVM 210. The compression ratio of the compressed data CD may represent a rate of capacity reduction as the write data WD is compressed into the compressed data CD. For example, when the write data WD is 100 MB and the compressed data CD is 90 MB, the compression ratio may be 10 %.

In some implementations, when the current usage of the NVM 210 exceeds the previous maximum usage after the compressed data CD is written on the NVM 210, the storage controller 220 may set the compression reserved space of the NVM 210 as the additional space 211 of the buffer memory 240 on the basis of the compression ratio.

When the current usage of the NVM 210 exceeds the previous maximum usage after the compressed data CD is written, it may indicate that there is a compression reserved space, which is a less used space compared to the space where the write data WD is written, as the compressed data CD is written in a previously unused space in the NVM 210. Here, based on the compression ratio, the storage controller 220 may set the compression reserved space of the NVM 210 as the additional space 211 of the buffer memory 240.

The additional space 211 of the buffer memory 240 may represent a space that exists inside of the NVM 210, but may be utilized as memory, such as the buffer memory 240, by the host device 100. That is, the additional space 211 belongs to the inside of the NVM 210 but may be utilized as cache memory by the host device 100.

In implementations, after setting the additional space 211, the storage controller 220 may transmit additional space information ASI to the host device 100. The additional space information ASI includes information about the capacity of the additional space 211, and the host device 100 may utilize the additional space 211 of the buffer memory 240 on the basis of the additional space information ASI received from the storage controller 220.

In some implementations, the buffer memory 240 may store hot data and the additional space 211 of the buffer memory 240 may store cold data. The hot data may represent data that is accessed relatively more frequently by the host device 100, and the cold data may represent data that is accessed relatively less frequently by the host device 100. Here, the hot data that is relatively more frequently accessed by the host device 100 may be stored in the buffer memory 240, which is easier to access by the host device 100 than the additional space 211, and the cold data that is relatively less frequently accessed by the host device 100 may be stored in the additional space 211, which is more difficult to access by the host device 100 than the buffer memory 240. Accordingly, the access speed to the buffer memory 240 and the additional space 211 by the host device 100 may increase.

In implementations, when the current usage of the NVM 210 does not exceed the previous maximum usage after the compressed data CD is written on the NVM 210, the storage controller 220 may maintain the preset additional space 211.

When the current usage of the NVM 210 does not exceed the previous maximum usage after the compressed data CD is written, it may indicate that the compressed data CD is written in a previously used space in the NVM 210. In this case, the additional space 211 corresponding to a space of the NVM 210, in which the compressed data CD was recently stored, has been previously reserved, and thus, the storage controller 220 may maintain the preset additional space 211 without further setting the additional space 211.

In implementations, when the current usage of the NVM 210 exceeds the previous maximum usage, the storage controller 220 may set the compression reserved space of the NVM 210 as the additional space 211 of the buffer memory 240 once the compression ratio exceeds a reference compression ratio.

The reference compression ratio represents a ratio based on which it is determined whether or not to set the compression reserved space of the NVM 210 as the additional space 211 of the buffer memory 240, and the reference compression ratio may be preset by a user. When the compression ratio is too low, even if the compression reserved space of the NVM 210 is set as the additional space 211 of the buffer memory 240, the additional space 211 of the buffer memory 240 may be too small to be substantially utilized by the host device 100. When the compression ratio exceeds the reference compression ratio, the storage controller 220 may set the compression reserved space of the NVM 210 as the additional space 211 of the buffer memory 240, thereby preventing the additional space 211 of the buffer memory 240 from being wasted.

Conversely, when the compression ratio does not exceed the reference compression ratio, the storage controller 220 may maintain the preset additional space 211.

In some implementations, when a space for writing the compressed data CD on the NVM 210 is insufficient, the storage controller 220 may transfer the data stored in the additional space 211 to an external storage device. That is, the storage controller 220 may transfer the additional space 211 to the external storage device, thereby reserving a space in which the compressed data CD is to be written.

In the implementations shown in FIG. 1 (hereinafter, the plurality of storage devices 200_1 to 200_N described above may be referred to as the first to Nth storage devices 200_1 to 200_N), when a space for writing the compressed data CD on a first NVM in the first storage device 200_1 is insufficient, a first storage controller in the first storage device 200_1 may transfer the data stored in a first additional space of the first storage device 200_1 to any of the second to the Nth storage devices 200_2 to 200_N, which represent external storage devices.

In some implementations, when a space for writing the compressed data CD on the NVM 210 is insufficient, the storage controller 220 may determine whether or not to transfer the data stored in the additional space 211 to the external storage devices. The storage controller 220 may determine whether a space (e.g., a buffer memory of an external storage device or an additional space of the buffer memory of the external storage device), in which the data stored in the additional space 211 is to be stored, exists in the external storage device and may thus determine whether the data stored in the additional space 211 may be transferred to the external storage device.

Next, when determining that the data stored in the additional space 211 is transferable to the external storage device, the storage controller 220 may transfer the data stored in the additional space 211 to the external storage device. That is, when the data stored in the additional space 211 is transferable to the external storage device, the storage controller 220 may transfer the data stored in the additional space 211 to the external storage device.

Here, the storage controller 220 may determine whether the data stored in the additional space 211 is transferable to the buffer memory in the external storage device or to the additional space of the buffer memory in the external storage device and may thus determine whether the data stored in the additional space 211 is transferable to the external storage device. When determining that the data stored in the additional space 211 is transferable to the external storage device, the storage controller 220 may transfer the data stored in the additional space 211 to the buffer memory in the external storage device or to the additional space of the buffer memory in the external storage device.

In the implementations shown in FIG. 1, when a space for writing the compressed data CD on the first NVM in the first storage device 200_1 is insufficient, the first storage controller in the first storage device 200_1 may determine that the data stored in the first additional space in the first storage device 200_1 is transferable to the second storage device 200_2. Here, the first storage controller may determine whether the data stored in the first additional space is transferable to a second buffer memory in the second storage device 200_2 or to a second additional space of the second buffer memory and may thus determine whether the data stored in the first additional space is transferable to the second storage device 200_2.

Next, when determining that the data stored in the first additional space is transferable to the second storage device 200_2, the first storage controller may transfer the data stored in the first additional space to the second storage device 200_2. Here, the second storage device 200_2 may store the data, which has been stored in the first additional space and received from the first storage device 200_1, in the second buffer memory or the second additional space.

In some implementations, after transferring the data stored in the additional space 211 to the external storage device, the storage controller 220 may store a bridge link between the external storage device and the buffer memory 240. Through the bridge link, the storage controller 220 may access the data stored in the additional space 211 even if the data has been transferred to the external storage device.

In the implementations shown in FIG. 1, the first storage controller in the first storage device 200_1 may transfer the data stored in the first additional space in the first storage device 200_1 to the second storage device 200_2, and may then store a bridge link between a space in the second storage device 200_2, which stores the data stored in the first additional space, and a first buffer memory. That is, the first storage controller may store a bridge link between the second buffer memory or the second additional space and the first buffer memory.

As described above, the storage device 200 according to some implementations may set the compression reserved space as the additional space 211 of the buffer memory 240, and thus, the host device 100 may utilize the space obtained by compressing the write data WD. Accordingly, free spaces in the storage device 200 may be utilized efficiently.

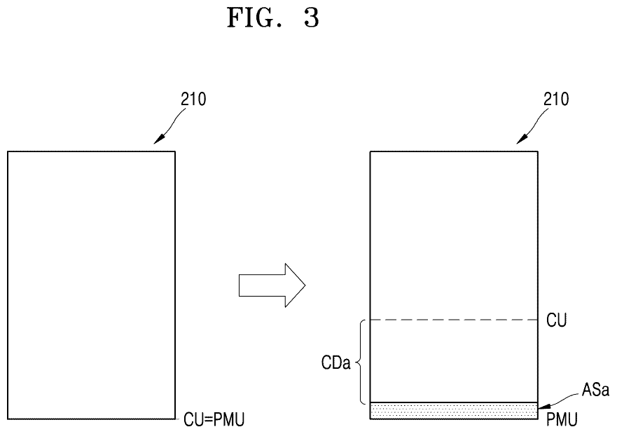

FIG. 3 is a diagram illustrating some implementations in which data is initially written on the NVM 210 of the storage device 200.

Referring to FIG. 3, a diagram illustrates a change in the inner space of the NVM 210 as compressed data a(CDa) is written on the NVM 210 of the storage device 200.

In the drawings of FIGS. 3 to 7, a current usage CU and a previous maximum usage PMU shown in the NVM 210 may represent a space corresponding to a region of the NVM 210 from the lowermost end thereof to the dashed line.

First, referring to the NVM 210 shown on the left side of FIG. 3, the NVM 210 may initially be in a state in which both the current usage CU and the previous maximum usage PMU are zero.

Here, when the compressed data a(CDa) is written on the NVM 210, the current usage CU may exceed the previous maximum usage PMU. Here, in the implementations of FIG. 3, it may be assumed that the compression ratio exceeds the reference compression ratio. Accordingly, the storage controller 220 may set the compression reserved space of the NVM 210 as an additional space of the buffer memory 240.

Accordingly, referring to the NVM 210 shown on the right side of FIG. 3, the previous maximum usage PMU may be the same as the previous maximum usage PMU before the compressed data a(CDa) shown on the left side of FIG. 3 is written. Then, an additional space a(ASa), such as a region shaded in gray, may be set as the additional space of the buffer memory 240 by the storage controller 220. Finally, the current usage CU may be shown as a region from the lowermost end of the NVM 210 to the dashed line, corresponding to the additional space a(ASa) and a space of storing the compressed data a(CDa).

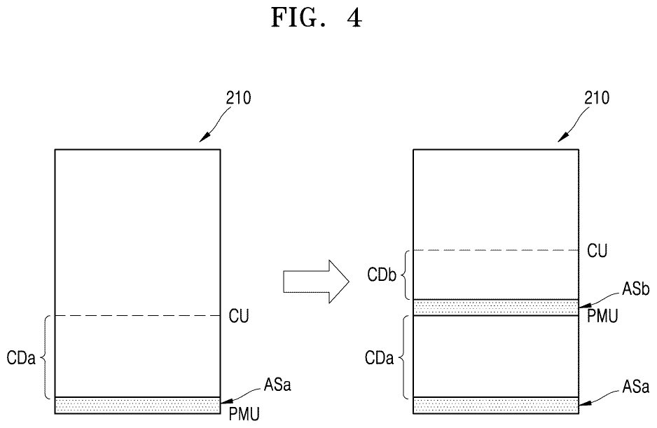

FIG. 4 is a diagram illustrating some implementations in which data in excess of the previous maximum usage is additionally written on the NVM 210 of the storage device 200.

Referring to FIG. 4, a diagram illustrates a change in the inner space of the NVM 210 as compressed data b(CDb) is additionally written on the NVM 210 in a state in which the compressed data a(CDa) has been written on the NVM 210, such as the state on the right side of FIG. 3.

First, referring to the NVM 210 shown on the left side of FIG. 4, the NVM 210 may be in a state in which the compressed data a(CDa) is stored and the additional space a(ASa) is set.

Here, when the compressed data b(CDb) is written on the NVM 210, the current usage CU may exceed the previous maximum usage PMU. Here, in the implementations of FIG. 4, it may be assumed that the compression ratio exceeds the reference compression ratio. Accordingly, the storage controller 220 may set the compression reserved space of the NVM 210 as an additional space of the buffer memory 240.

Accordingly, referring to the NVM 210 shown on the right side of FIG. 4, the previous maximum usage PMU may be the same as the current usage CU immediately after the compressed data a(CDa) shown on the left side of FIG. 4 is written. Then, an additional space b(ASb), such as a region shaded in gray, may be set as the additional space of the buffer memory 240 by the storage controller 220. Finally, the current usage CU may be shown as a region from the lowermost end of the NVM 210 to the dashed line, corresponding to the additional space a(ASa), a space of storing the compressed data a(CDa), the additional space b(ASb), and the space of storing the compressed data b(CDb).

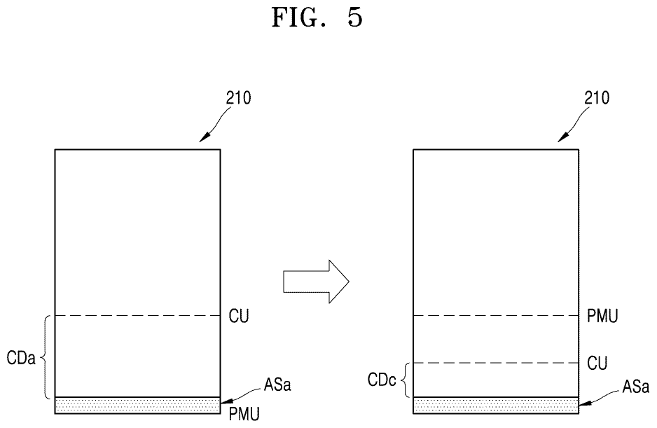

FIG. 5 is a diagram illustrating some implementations in which the data written on the NVM 210 of the storage device 200 is erased.

Referring to FIG. 5, a diagram illustrates a change in the inner space of the NVM 210 as the compressed data a(CDa) is partially removed from the NVM 210 in a state in which the compressed data a(CDa) has been written on the NVM 210, such as the state on the right side of FIG. 3.

First, referring to the NVM 210 shown on the left side of FIG. 5, the NVM 210 may be in a state in which the compressed data a(CDa) is stored and the additional space a(ASa) is set.

Here, when the compressed data a(CDa) is partially removed from the NVM 210, the current usage CU may not exceed the previous maximum usage PMU. Here, the storage controller 220 may maintain a preset additional space, i.e., the additional space a(ASa).

Accordingly, referring to the NVM 210 shown on the right side of FIG. 5, the previous maximum usage PMU may be the same as the current usage CU before the compressed data a(CDa) shown on the left side of FIG. 5 has been partially deleted. Then, the current usage CU may be shown as a region from the lowermost end of the NVM 210 to the dashed line, corresponding to the additional space a(ASa) and a space of storing compressed data c(CDc) remaining after the compressed data a(CDa) has been partially deleted. Finally, the additional space a(ASa) may remain the same as in the diagram on the left side of FIG. 5.

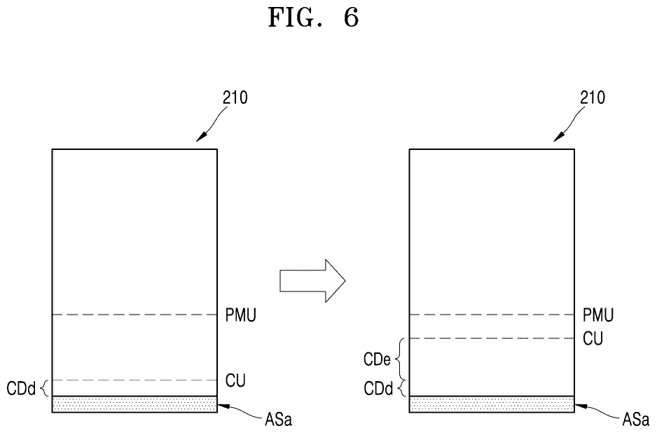

FIG. 6 is a diagram illustrating some implementations in which data not exceeding the previous maximum usage is written on the NVM 210 of the storage device 200.

Referring to FIG. 6, a diagram illustrates a change in the inner space of the NVM 210 as compressed data e(CDe) is additionally written in a state in which compressed data d(CDd) has been written, such as the state on the left side of FIG. 6.

First, referring to the NVM 210 shown on the left side of FIG. 6, the NVM 210 may be in a state in which the compressed data d(CDd) is stored and the additional space a(ASa) is set.

Here, when the compressed data e(CDe) is additionally written on the NVM 210, the current usage CU may not exceed the previous maximum usage PMU. Here, the storage controller 220 may maintain a preset additional space, i.e., the additional space a(ASa).

Accordingly, referring to the NVM 210 shown on the right side of FIG. 6, the previous maximum usage PMU may be the same as the previous maximum usage PMU before the compressed data e(CDe) shown on the left side of FIG. 6 is additionally written. Then, the current usage CU may be shown as a region from the lowermost end of the NVM 210 to the dashed line, corresponding to the additional space a(ASa), a space of storing the compressed data d(CDd), and a space of storing the compressed data e(CDe). Finally, the additional space a(ASa) may remain the same as in the diagram on the left side of FIG. 6.

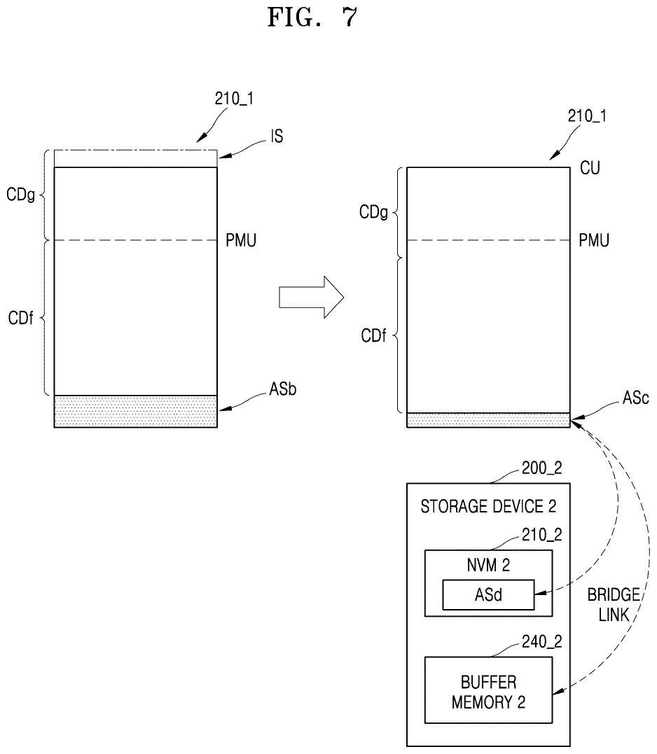

FIG. 7 is a diagram illustrating an operation of a storage device according to some implementations when a space for writing compressed data on an NVM is insufficient.

Referring to FIG. 7, the diagram on the left side of FIG. 7 illustrates a change in the inner space of a first NVM 210_1 of the first storage device 200_1 as compressed data g(CDg) is additionally written on the first NVM 210_1 in a state in which compressed data f(CDf) has been written on the first NVM 210_1.

First, referring to the first NVM 210_1 shown on the left side of FIG. 7, the first NVM 210_1 may be in a state in which the compressed data f(CDf) is stored and the additional space b(ASb) is set. Here, the compressed data g(CDg) has to be additionally written on the first NVM 210_1, but the capacity of the compressed data g(CDg) may be more than the remaining capacity of the first NVM 210_1, resulting in an insufficient space IS. The insufficient space IS may represent a space that is additionally required to store compressed data.

Since a space for writing the compressed data g(CDg) is insufficient, the first storage controller of the first storage device 200_1 may transfer the data stored in the additional space b(ASb) to the second storage device 200_2. Here, the first storage controller may be in a state in which the first storage controller has determined that the data stored in the additional space b(ASb) is transferable to the second storage device 200_2.

Accordingly, referring to the first NVM 210_1 shown on the right side of FIG. 7, the data stored in the additional space b(ASb) may be partially transferred to the second storage device 200_2. Data remaining in the first NVM 210_1 among the data stored in the additional space b(ASb) may be present in an additional space c(ASc). On the other hand, data that has been transferred to the second storage device 200_2 among the data stored in the additional space b(ASb) may be stored in second buffer memory 240_2 of the second storage device 200_2 or in an additional space d(ASd) that is an additional space of the second buffer memory 240_2. Here, the first storage controller may store a bridge link between the additional space c(ASc) and the second buffer memory 240_2 or the additional space d(ASd).

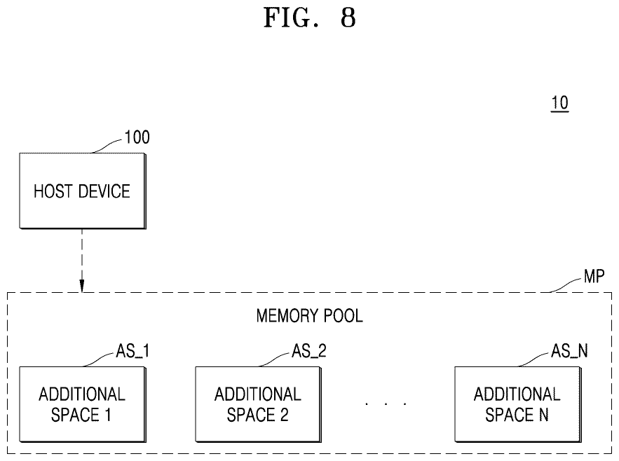

FIG. 8 is a diagram illustrating some implementations in which an additional space in a storage device is utilized as a memory pool.

FIG. 8 shows an example in which a plurality of additional spaces AS_1 to AS_N included in a plurality of storage devices 200_1 to 200_N, respectively, are configured as a memory pool MP.

The plurality of storage devices 200_1 to 200_N may set the compression reserved spaces as the plurality of additional spaces AS_1 to AS_N, respectively, as described above. Here, the host device 100 may utilize the plurality of additional spaces AS_1 to AS_N as the memory pool MP. As described above, the host device 100 may use, as the memory pool MP, the plurality of additional spaces AS_1 to AS_N set in the plurality of storage devices 200_1 to 200_N, respectively, and thus, the operating speed of the host device 100 may be improved.

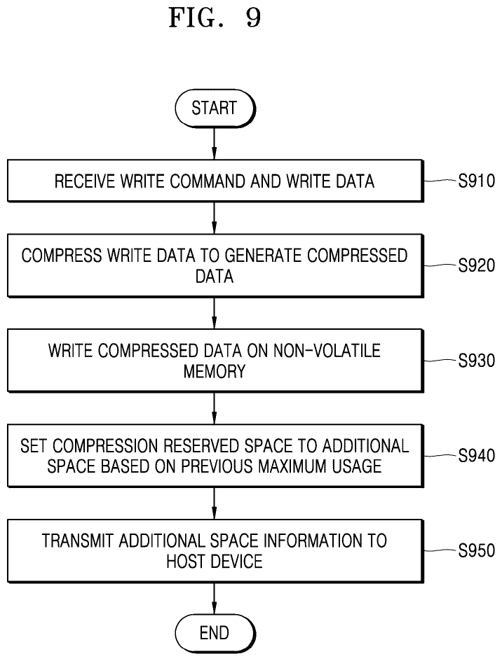

FIG. 9 is a flowchart illustrating an operating method of a storage device, according to some implementations.

Referring to FIG. 9, in operation S910, the storage device 200 may receive the write command and the write data via the storage controller 220. The storage controller 220 may receive the write command and the write data, which are generated from the host device 100, via the host interface 221.

In operation S920, the storage device 200 may compress the write data via the compressor 230 to generate compressed data. The compressor 230 may compress the write data received from the storage controller 220 to generate the compressed data.

In operation S930, the storage device 200 may write the compressed data on the NVM 210. The compressor 230 may write the compressed data generated in operation S920 on the NVM 210.

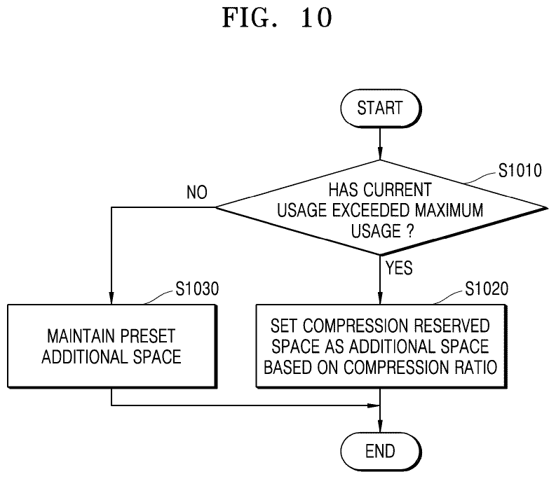

In operation S940, the storage device 200 may set the compression reserved space as the additional space on the basis of the previous maximum usage, by using the storage controller 220. The storage controller 220 may compare the previous maximum usage of the NVM 210 to the current usage of the NVM 210 and may set the compression reserved space as the additional space. This is described in more detail with reference to FIG. 10.

FIG. 10 is a flowchart illustrating a method in which the storage device according to some implementations sets the additional space on the basis of the previous maximum usage.

Referring to FIG. 10, in operation S1010, the storage device 200 may determine whether the current usage exceeds the previous maximum usage, by using the storage controller 220.

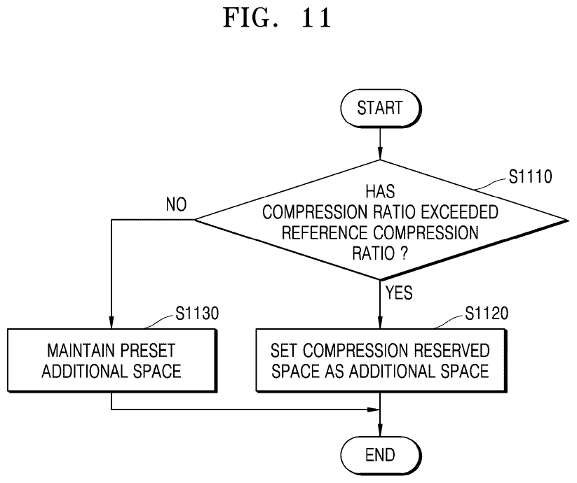

When it is determined that the current usage exceeds the previous maximum usage, the storage device 200 may move to operation S1020 and set the compression reserved space as the additional space on the basis of the compression ratio via the storage controller 220. The storage controller 220 may set the compression reserved space as the additional space on the basis of the compression ratio of the write data via the compressor 230. This is described in more detail with reference to FIG. 11.

FIG. 11 is a flowchart illustrating a method in which the storage device according to some implementations sets the additional space on the basis of the compression ratio.

Referring to FIG. 11, in operation S1110, the storage device 200 may determine whether the compression ratio exceeds the reference compression ratio, by using the storage controller 220.

When the compression ratio exceeds the reference compression ratio, the storage device 200 may move to operation S1120 and set the compression reserved space as the additional space via the storage controller 220.

On the other hand, when the compression ratio does not exceed the reference compression ratio, the storage device 200 may move to operation S1130 and maintain the preset additional space via the storage controller 220.

Referring back to FIG. 10, when it is determined in operation S1010 that the current usage does not exceed the previous maximum usage, the storage device 200 may move to operation S1030 and maintain the preset additional space via the storage controller 220.

Referring back to FIG. 9, in operation S950, the storage device 200 may transmit the additional space information to the host device 100 via the storage controller 220. The storage controller 220 may transmit the additional space information to the host device 100 via the host interface 221. Accordingly, the host device 100 may utilize the additional space as cache memory. Also, the additional space may be included in the memory pool and utilized by the host device 100.

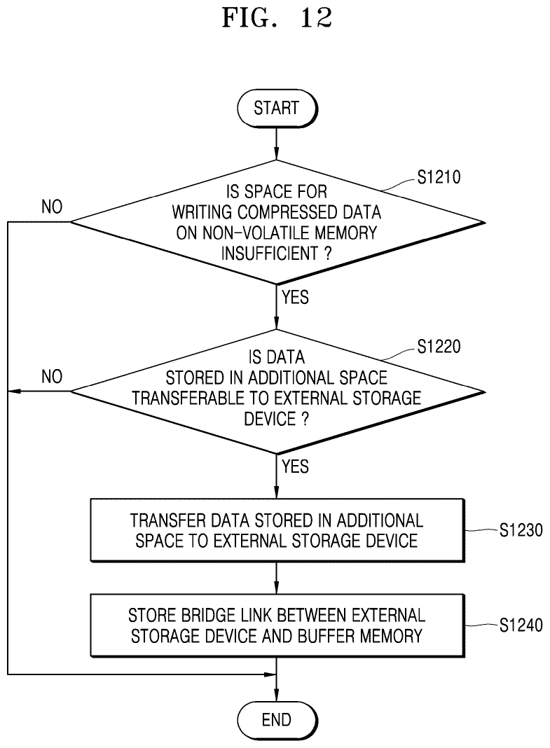

FIG. 12 is a flowchart illustrating an operating method of the storage device according to some implementations when a space for writing the compressed data on the NVM is insufficient.

Referring to FIG. 12, in operation S1210, the storage device 200 may determine whether a space for writing the compressed data to the NVM 210 is insufficient, by using the storage controller 220. The storage controller 220 may compare the volume of the compressed data to the remaining capacity of the NVM 210 and determine whether a space for writing the compressed data on the NVM 210 is insufficient.

When a space for writing the compressed data on the NVM 210 is not insufficient, the method may be terminated without performing any further operation.

On the other hand, when a space for writing the compressed data on the NVM 210 is insufficient, the storage device 200 may move to operation S1220 and determine whether the data stored in the additional space is transferable to the external storage device, by using the storage controller 220. The storage controller 220 may determine whether a space (e.g., a buffer memory of an external storage device or an additional space of the buffer memory of the external storage device), in which the data stored in the additional space 211 is to be stored, exists in the external storage device and may thus determine whether the data stored in the additional space 211 may be transferred to the external storage device.

When it is determined that the data stored in the additional space 211 is not transferable to the external storage device, the method may be terminated without performing any further operation.

On the other hand, when the data stored in the additional space 211 is transferable to the external storage device, the storage device 200 may move to operation S1230 and transfer the data stored in the additional space 211 to the external storage device via the storage controller 220. Here, the storage controller 220 may transfer the data stored in the additional space 211 to the buffer memory of the external storage device or to the additional space of the buffer memory in the external storage device.

In operation S1240, the storage device 200 may store the bridge link between the external storage device and the buffer memory 240 via the storage controller 220. The storage controller 220 may store the bridge link between the buffer memory 240 and the space in the external storage device where the data stored in the additional space 211 is transferred and stored.

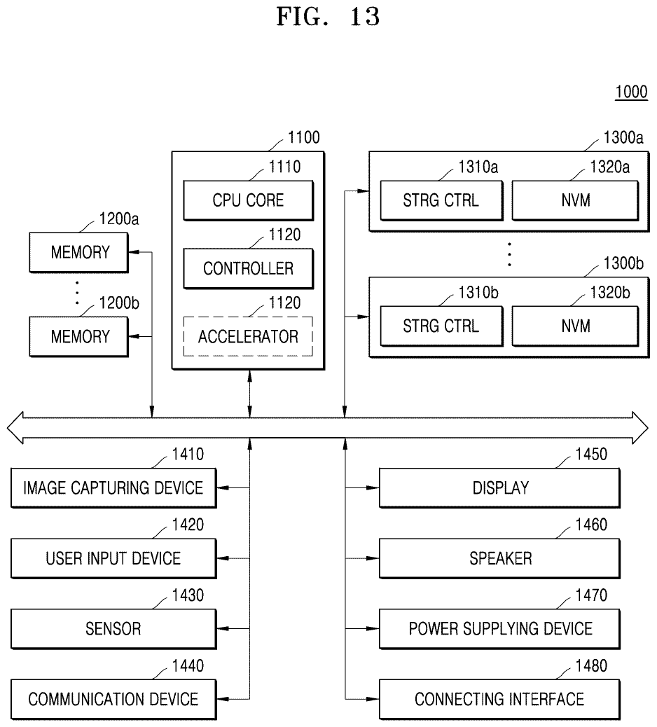

FIG. 13 is a diagram illustrating a system 1000 having a storage device according to some implementations.

The system 1000 of FIG. 13 may basically include mobile systems, such as a portable mobile phone, a smartphone, a tablet PC, a wearable device, a healthcare device, and an IoT device. However, the system 1000 of FIG. 13 is not necessarily limited to the mobile systems described above and may include a PC, a laptop, a server, a media player, an automotive device such as a navigation unit, or the like.

Referring to FIG. 13, the system 1000 may include a main processor 1100, memory 1200a and 1200b, and storage devices 1300a and 1300b, and may further include one or more of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, and more specifically, operations of all other components that constitute the system 1000. The main processor 1100 may be provided as a general-purpose processor, a dedicated processor, or an AP.

The main processor 1100 may include one or more CPU cores 1110 and may further include a controller 1120 for controlling the memory 1200a and 1200b and/or the storage devices 1300a and 1300b. According to some implementations, the main processor 1100 may further include an accelerator 1130, which includes a dedicated circuit for high-speed data computation, such as artificial intelligence (AI) data computation. The accelerator 1130 may include a graphics processing unit (GPU), a neural processing unit (NPU), and/or a data processing unit (DPU) and may be provided as a separate chip physically independent from other components of the main processor 1100.

The memory 1200a and 1200b may be used as main memory devices of the system 1000 and include volatile memory, such as static random-access memory (SRAM) and dynamic random-access memory (DRAM). However, the memory 1200a and 1200b may also include NVM, such as flash memory, PRAM, and/or RRAM. The memory 1200a and 1200b may also be provided in the same package as the main processor 1100.

The storage devices 1300a and 1300b may function as non-volatile storage devices for storing data regardless of whether power is supplied or not thereto and may have storage capacities relatively greater than those of the memory 1200a and 1200b. The storage devices 1300a and 1300b may respectively include storage controllers 1310a and 1310b and NVM 1320a and 1320b that store data under the control by the storage controllers 1310a and 1310b. The NVM 1320a and 1320 b may include flash memory with a 2-dimensional (2D) structure or a 3-dimensional (3D) vertical NAND (V-NAND) structure but may also include other types of NVM, such as PRAM and RRAM.

The storage devices 1300a and 1300b may be provided in the system 1000 while being physically separated from the main processor 1100 or may be provided in the same package as the main processor 1100. In addition, the storage devices 1300a and 1300b may be formed as an SSD or a memory card and thus detachably coupled to other components of the system 1000 via an interface, such as the connecting interface 1480 described below. The storage devices 1300a and 1300b may include devices, to which standard regulations are applied, such as UFS, eMMC, and NVMe, but the implementations are not necessarily limited thereto.

The main processor 1100 of the system 1000 in FIG. 13 may be configured to include the host device 100 described above with reference to FIGS. 1 to 12. In addition, the storage devices 1300a and 1300b of the system 1000 in FIG. 13 may be configured to include the storage device 200 described above with reference to FIGS. 1 to 12.

The image capturing device 1410 may capture still images or moving images and include a camera, a camcorder, and/or a webcam.

The user input device 1420 may receive various types of data input from a user of the system 1000 and include a touch pad, a keypad, a keyboard, a mouse, and/or a microphone.

The sensor 1430 may sense various types of physical quantities obtained from outside the system 1000 and convert the sensed physical quantities into electrical signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals to and from other devices outside the system 1000 according to various communication protocols. The communication device 1440 may include an antenna, a transceiver, and/or a modem.

The display 1450 and the speaker 1460 may function as output devices that output visual information and auditory information, respectively, to a user of the system 1000.

The power supplying device 1470 may appropriately convert power supplied from a battery (not shown) built in the system 1000 and/or an external power source and may supply the converted power to each of the components of the system 1000.

The connecting interface 1480 may provide connection between the system 1000 and an external device which is connected to the system 1000 to exchange data with the system 1000. The connecting interface 1480 may be provided in various interface methods, such as ATA, SATA, e-SATA, SCSI, SAS, PCI, PCIe, NVMe, IEEE 1394, USB, an SD card interface, MMC, eMMC, UFS, eUFS, and a CF card interface.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the storage device has been particularly shown and described with reference to implementations thereof, it will be understood that various changes in form and details may be made therein without departing from the spirit and scope of the following claims.

What is claimed is:

1. A storage device comprising:
non-volatile memory;
a storage controller configured to receive a write command and write data from a host device;
a compressor configured to compress the write data to provide compressed data, and write the compressed data to the non-volatile memory; and
buffer memory configured to be used by the host device,
wherein the storage controller is configured to, based on a previous maximum usage of the non-volatile memory and a compression ratio of the compressed data, set a compression reserved space of the non-volatile memory as an additional space of the buffer memory, and to transmit information about the additional space to the host device.

2. The storage device of claim 1, wherein the storage controller is configured to set the compression reserved space of the non-volatile memory as the additional space of the buffer memory, after the compressed data is written to the non-volatile memory, based on a current usage of the non-volatile memory exceeding the previous maximum usage.

3. The storage device of claim 2, wherein the storage controller is configured to set the compression reserved space of the non-volatile memory as the additional space of the buffer memory based on the compression ratio exceeding a reference compression ratio.

4. The storage device of claim 1, wherein the information about the additional space comprises a capacity of the additional space.

5. The storage device of claim 1, wherein the storage controller is configured to maintain the additional space, after the compressed data is written to the non-volatile memory, based on a current usage of the non-volatile memory being less than or equal to the previous maximum usage.

6. The storage device of claim 1, wherein the storage controller is configured to transfer data stored in the additional space to an external storage device and store a bridge link between the external storage device and the buffer memory, based on a space for writing the compressed data to the non-volatile memory being insufficiently large enough to store the compressed data.

7. The storage device of claim 1, wherein the storage controller is configured to:
determine that data stored in the additional space is transferable to an external storage device, based on a space for writing the compressed data to the non-volatile memory being insufficiently large enough to store the compressed data; and
transfer the data stored in the additional space to the external storage device and store a bridge link between the external storage device and the buffer memory, based on determining that the data stored in the additional space is transferable to the external storage device.

8. The storage device of claim 1, wherein the buffer memory is configured to store hot data, and
the additional space of the buffer memory is configured to store cold data.

9. An operating method of a storage device comprising non-volatile memory, a storage controller, a compressor, and buffer memory, the operating method comprising:
receiving, by the storage controller, a write command and write data from a host device;
compressing, by the compressor, the write data to generate compressed data;
writing, by the compressor, the compressed data to the non-volatile memory;
setting, by the storage controller, a compression reserved space of the non-volatile memory as an additional space of the buffer memory, based on a previous maximum usage of the non-volatile memory; and
transmitting, by the storage controller, information about the additional space to the host device.

10. The operating method of claim 9, wherein setting the compression reserved space of the non-volatile memory as the additional space of the buffer memory is based on a compression ratio when a current usage of the non-volatile memory exceeds the previous maximum usage.

11. The operating method of claim 10, wherein setting the compression reserved space of the non-volatile memory as the additional space of the buffer memory based on the compression ratio comprises setting the compression reserved space of the non-volatile memory as the additional space of the buffer memory when the compression ratio exceeds a reference compression ratio.

12. The operating method of claim 9, comprising maintaining, by the storage controller, the additional space, based on a current usage of the non-volatile memory being less than or equal to the previous maximum usage after the compressed data is written to the non-volatile memory.

13. The operating method of claim 9, comprising:
transferring, by the storage controller, data stored in the additional space to an external storage device when a space for writing the compressed data to the non-volatile memory is insufficiently large enough to store the compressed data; and
storing, by the storage controller, a bridge link between the external storage device and the buffer memory.

14. The operating method of claim 9, further comprising:
determining, by the storage controller, that data stored in the additional space is transferable to an external storage device based on a space for writing the compressed data to the non-volatile memory being insufficiently large enough to store the compressed data;
transferring, by the storage controller, the data stored in the additional space to the external storage device, based on determining that the data stored in the additional space is transferable to the external storage device; and
storing, by the storage controller, a bridge link between the external storage device and the buffer memory.

15. The operating method of claim 9, wherein the buffer memory is configured to store hot data, and
the additional space of the buffer memory is configured to store cold data.

16. A computing system comprising:
a host device;
a first storage device comprising first non-volatile memory, a first storage controller, a first compressor, and first buffer memory; and
a second storage device comprising second non-volatile memory, a second storage controller, a second compressor, and second buffer memory,
wherein the first storage device is configured to:
receive a write command and write data and compress the write data to generate compressed data;
write the compressed data to the first non-volatile memory;
set a compression reserved space of the first non-volatile memory as a first additional space of the first buffer memory, based on a previous maximum usage of the first non-volatile memory; and
transfer data stored in the first additional space to the second storage device, based on a space for writing the compressed data to the first non-volatile memory being insufficiently large enough to store the compressed data.

17. The computing system of claim 16, wherein the first storage device is configured to:
determine that the data stored in the first additional space is transferable to the second storage device based on the space for writing the compressed data to the first non-volatile memory being insufficiently large enough to store the compressed data; and
transfer the data stored in the first additional space to the second storage device, based on determining that the data stored in the first additional space is transferable to the second storage device.

18. The computing system of claim 16, wherein the second storage device is configured to, upon receiving the data stored in the first additional space, store the data stored in the first additional space in the second buffer memory or in a second additional space of the second buffer memory.

19. The computing system of claim 16, wherein the first storage device is configured to transfer the data stored in the first additional space to the second storage device and store a bridge link between a space inside the second storage device, the second storage device storing the data stored in the first additional space, and the first buffer memory.

20. The computing system of claim 16, wherein the host device is configured to use the first additional space and a second additional space as a memory pool.
